(19) United States
(12) Patent Application Publication
(10) Pub. No.: US 2024/0322714 A1
(43) Pub. Date: Sep. 26, 2024

(54) USING A CAPACITOR AS A POWER SOURCE FOR PERSONAL TRANSPORTATION DEVICES

(71) Applicant: Declan Kurant, Washington, DC (US)

(72) Inventor: Declan Kurant, Washington, DC (US)

(21) Appl. No.: 18/597,838

(22) Filed: Mar. 6, 2024

Related U.S. Application Data
(60) Provisional application No. 63/488,706, filed on Mar. 6, 2023.

(51) Int. Cl. H02P 4/00; H02K 5/22

(52) U.S. Cl. CPC H02P 4/00; H02K 5/225

(57) ABSTRACT

The present invention is a system and method for providing a secondary power source for a personal transportation device, wherein the secondary power source is at least one capacitor that is electrically coupled to a primary power source to extend a useful range of the single user transportation device, wherein the secondary power source may also provide a power increase to the primary power source when required, and wherein the secondary power source may also provide a power buffer and include spark suppression that will extend a useful life of an electrical system and the primary power source.

### BACKGROUND

### Field of the Invention

This invention relates generally to power sources for personal transportation devices, wherein the power source is not a general-purpose battery but instead one or more capacitors that typically have undesirable voltage output for electric motors.

### Description of Related Art

The prior art teaches that batteries are a preferred power source for personal transportation devices. Such personal transportation devices include such devices as electric unicycles, electric scooters, electric motorcycles, electric bicycles, electric hoverboards, and SEGWAY™ type devices. It should be understood that some of these personal transportation devices may carry more than one person, but the subject matter of the invention is generally disposed toward the types of motors that can be used in a small transportation device. However, the invention may be capable of being scaled up or down in size and capacity as needed.

The prior art teaches that typical personal transportation devices are generally going to have a modest battery of a limited range and power. However, some of these personal transportation devices may be used as a primary means of transportation and therefore must be reliable and carry sufficient charge to travel at near roadway or roadway speeds. Other personal transportation devices may be used in sports or sporting activities and require large amounts of power for high speed or all-terrain maneuvering.

Given the limited amount of battery capacity typically found in these personal transportation devices, it would be an advantage over the prior art to provide a secondary or backup power source that will not require modification or only minimal modification of the personal transportation devices in order to include a secondary or backup power source.

Furthermore, it would be a further advantage if the secondary power source could be as small as or smaller than the primary power source so that significant weight is not being added to the personal transportation device which could affect balance and ease of use.

### BRIEF SUMMARY

The present invention is a system and method for providing a secondary power source for a personal transportation device, wherein the secondary power source is at least one capacitor that is electrically coupled to a primary power source to extend a useful range of the personal transportation device, wherein the secondary power source may also provide a power increase to the primary power source when required, and wherein the secondary power source may also provide a power buffer and include spark suppression that will extend a useful life of an electric motor system and the power sources.

These and other embodiments of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a block diagram of the components in an electrical motor system of the prior art.

FIG. 2 is a block diagram of the components in an electrical motor system of the first embodiment of the invention.

FIG. 3 is a block diagram of the wire harness that may be installed in the electric motor system to enable a first power source and a second power source to operate in parallel.

FIG. 4A is a block diagram of a second power source that uses a single capacitor.

FIG. 4B is a block diagram of a second power source that uses two capacitors.

FIG. 4C is a block diagram of a second power source that uses four capacitors.

### DETAILED DESCRIPTION

Reference will now be made to the drawings in which the various embodiments of the present invention will be discussed so as to enable one skilled in the art to make and use the invention. It is to be understood that the following description illustrates embodiments of the present invention and should not be viewed as narrowing the claims which follow.

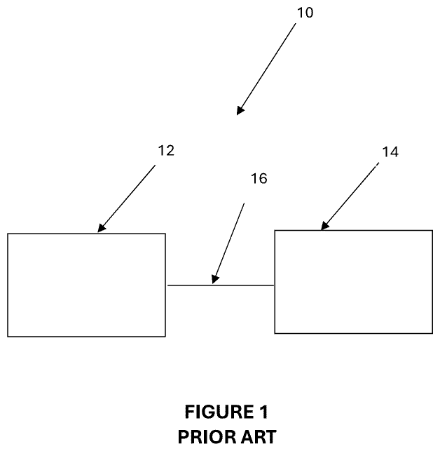

FIG. 1 is a block diagram of the components of an electric motor system 10 of the prior art that may be used in a personal transportation device (not shown). The electrical motor system 10 may include a first power source 12, an electric motor 14, and a cable 16 disposed from the power source to the electric motor. The electric motor 14 may include all of the electronic components of the electric motor such as a motherboard for controlling operation of the electric motor as well as a stator, a commutator, and a rotor of the electric motor.

It should be understood that the personal transportation device may be a single user or a multi-user personal transportation device, but which is designed as a personal transportation device for a small number of riders. Typical personal transportation devices that may take advantage of the present invention include devices selected from the group of personal transportation devices including but not limited to electric unicycles, electric scooters, electric motorcycles, electric bicycles, electric hoverboards, and SEGWAY™ type devices.

While the personal transportation device may be capable of transporting more than one person, the typical strain on an electrical motor and primary power source would be significant and would limit the range and power of the personal transportation device.

The first power source 12 shown in FIG. 1 may be a battery that is already installed on a personal transportation device (not shown). The battery being used as the first power source 12 is not a limitation of the present invention and may be any type of battery that is known to those skilled in the art and typically found in personal transportation devices. For example, the battery may be a lead acid, lithium ion, sodium ion, or any other battery that may be used to power a personal transportation device.

One of the main issues of any electrically powered personal transportation device may be the power source. The power source not only needs to be able to provide power in normal operating conditions, but also in atypical operation conditions. For example, operating on flat surfaces or in slight inclines, the power source may provide sufficient power. However, a standard power source may not be able to provide the power needed to operate when power demands sharply increase.

For example, when a personal transportation device needs to go up a sharp incline, the power source may only be capable of providing a slight increase in power. In other words, a typical power source for an electric motor may have limited energy for providing short bursts of power when the demand for power suddenly increases. The typical result is that performance of the personal transportation device in high energy demand situations may be sacrificed in order to provide an adequate energy needs for most circumstances.

The tradeoff of only providing enough power for most circumstances may often be a dangerous sacrifice. For example, the personal transportation device may need extra power in dangerous operating conditions. For example, weather conditions or objects that move into the path of the personal transportation device may require a sudden burst of speed to reach safety.

However, it is not only the operating conditions where power may be needed. Some personal transportation devices require power for the device to remain stable and upright, such as with a SEGWAY device or an electric unicycle.

The embodiments of the present invention may therefore provide power to not only extend the life of a battery power source, but also provide power for higher electrical loads when a burst of speed is needed or when a hill is being climbed.

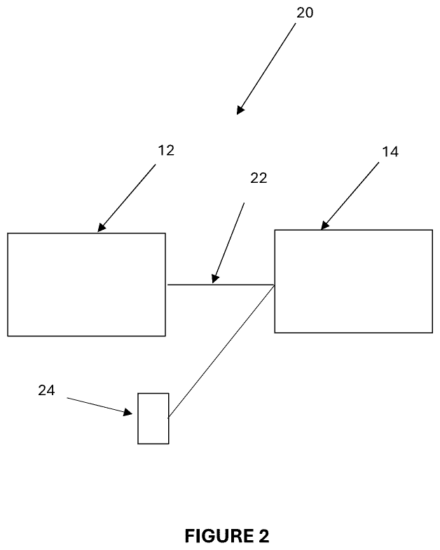

FIG. 2 is a block diagram of the first embodiment of the present invention. The first embodiment of an improved electric motor system 20 may include the first power source 12 and the original electric motor 14. However, the cable 16 is replaced with a new wire harness 22 that includes a connection to the power source and to a second power source 24.

The wire harness 22 may enable the first power source 12 and the second power source 24 to operate in parallel. In this way, the second power source may not only extend the range of the electric motor system 20 through a larger capacity of electrical power, but also provide an additional power boost when the electric load on the electric motor 14 surges by providing additional current. In this way, the electric motor system 20 not only operates for a longer period of time but is now capable of operating at a higher electrical current or voltage.

Thus, the electric power system 20 may provide additional power for traveling up an incline. The electric motor 14 may be capable of faster speeds up the incline, maintaining the same speed as before the incline, or simply not slowing down as much as it otherwise would without the second power source 24. Furthermore, the speed of the electric motor 14 may also be increased in short bursts to travel faster than what is possible with only the first power source 12.

Another way to describe the additional electrical power is to state that the second power source 24 may provide increased electrical capacity and/or increased electrical output. Thus, the addition of the second power source 24 may increase the effective amp hours of the first power source 12 or the current or voltage.

One of the advantages of the first embodiment of the invention as shown in FIG. 2 is the manner that the electric motor system 10 of FIG. 1 may be modified or retrofitted to create the electric motor system 20 as shown in FIG. 2. This ability to modify an existing system is important because it means that existing personal transportation devices may be modified to take advantage of the second power source 24.

To modify the electric motor system 10 of FIG. 1, the cable 16 is first removed from the system. Then the wire harness 22 is connected to the electric motor 14, the first power source 12, and to the second power source 24. The wire harness 22 places the first power source 12 and second power source 24 electrically in parallel.

In an alternative embodiment, the first power source 12 and the second power source 24 may be disposed electrically in series, but this configuration is not as advantageous.

The second power source 24 may have its own housing and be disposed on the outside of the personal transportation device. However, the first embodiment disposes the second power source 24 within or directly adjacent to the first power source 12. Ideally, the second power source 24 is disposed within a housing of the first power source 12. In this way, the overall weight caused by the addition of the second power source 24 is minimized. This is not only important for the distance that the personal transportation device can travel before the first and second power sources 12, 24 are depleted, but it may also be important to the balance of the personal transportation device.

For example, consider the example of an electric unicycle. The balance of such a device is important. A large and heavy second power source 24 could detrimentally affect the overall balance of the electric unicycle and remove any advantage of the second power source 24. Therefore, it is also critical that the weight of the second power source 24 be minimized. By not having to provide a housing just for the second power source 24, weight is reduced.

Advantageously, the physical structure of the second power source 24 may enable it to be placed within existing housings, as will be explained.

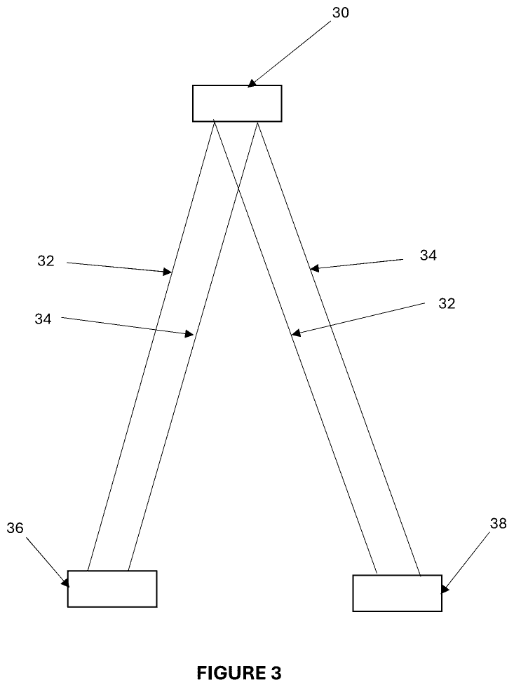

Before showing additional detail of the second power source 24, the wire harness 22 is shown in FIG. 3.

FIG. 3 is a block diagram of the wire harness 22. The motor connector 30 is electrically connected to the electric motor 14. There are two sets of wires or leads that extend from the motor connector 30. These may be considered to be positive leads 32 and negative leads 34. What is important is that the leads are connected to the same positive and negative leads of the first and second power sources 12, 24.

Therefore, a positive lead 32 and a negative lead 34 are electrically coupled to the first power source connector 36, and another positive lead 32 and another negative lead 34 are electrically coupled to the second power source connector 38.

The length of the positive leads 32 and the negative leads 34 will be sufficient to reach the first and second power sources 12, 24 and may be modified as necessary.

The motor connector 30, the first power source connector 36, and the second power source connector 38 are also important to the first embodiment of the invention. Specifically, it is important that the connectors include an anti-spark configuration. The anti-spark configuration means that the connectors may be removed from the devices they are connected to without creating a spark. It is very advantageous to be able to eliminate the danger of sparks that can be generated by connecting and disconnecting power cables such as the wire harness 22.

The anti-spark feature efficiently and safely protects power contacts in the connectors 30, 36, 38 from being burned and oxidized by electric sparks, and effectively protects the electronic components of integrated circuits from being damaged by piercing.

It may also be important that the wire harness 22 be capable of disconnecting from the second power source 24 if the second power source needs to be charged externally or replaced with another charged second power source. By providing the wire harness 22 with the anti-spark feature, electrical damage to the power sources 12, 24 and to the electric motor 14 is therefore reduced or eliminated.

The anti-spark feature of the wire harness 22 may be provided in the connectors 30, 36, and 38. For example, the connectors 30, 36, 38 may be XT90 or XT60 connectors, or a combination of both. When the connectors 30, 36, 38 include the anti-spark feature, they may be XT60-S or XT90-S connectors. It should also be understood that the use of XT60 and XT90 connectors is only an example of the connectors that may be used in the first embodiment of the invention, and any connectors that may be used to couple the electric motor to the first and second power sources 12, 24 may be used as long as they include the anti-spark feature.

The physical structure of the second power source 24 may also be a feature of the first embodiment of the invention because the physical structure may enable it to be disposed in tight spaces within a personal transportation device.

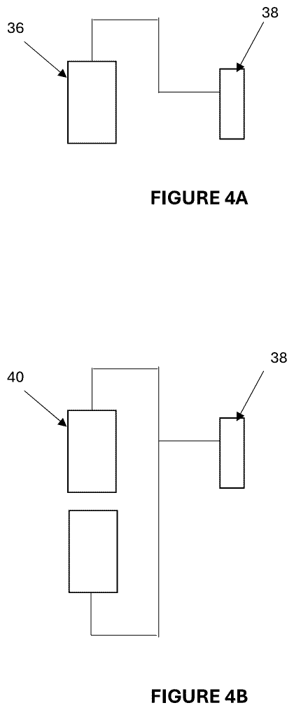

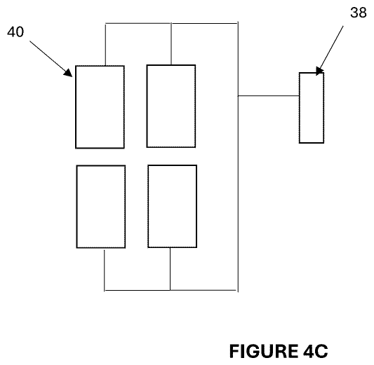

FIGS. 4A-4D are block diagrams of the layout of various embodiments of the second power source 24. First, FIG. 4A shows a single capacitor 40 that is functioning as the second power source 24. It should be understood that the second power source 24 may be comprised of 1 or more capacitors 40. FIG. 4A shows a single capacitor 40.

Alternatively, FIG. 4B and FIG. 4C show the use of two and four capacitors 40. It should also be understood that when multiple capacitors 40 are used in the second power source 24, that they may arranged in parallel or in series, or a combination of the two.

The capacitors used in the first embodiment of the invention may be aluminum electrolyte capacitors. However, any appropriate capacitor may be used, such as non-solid (liquid, wet) aluminum electrolytic capacitors, solid manganese dioxide aluminum electrolytic capacitors, or solid polymer aluminum electrolytic capacitors. This list should not be considered exhaustive as other types of capacitors may also be used.

It should be understood that the relative size of the capacitors 40 is typically going to be significantly smaller than the battery used as the first power source 12. Therefore, a housing for the battery used as the first power source 12 is typically going to include some empty space. Because of the relatively small size of the capacitors 40 used in the second power source 24, the second power source may be slipped inside a cover or bent so as to fit against the bottom of a lid or cover that is disposed over the first power source 12.

Those skilled in the art of power supplies understand that one benefit of using capacitors 40 or supercapacitors is that these devices may be smaller than a typical battery. In other words, the power density may be greater for a given amount of volume of the capacitors 40 as compared to a battery of the first power source 12.

Ideally, the retrofitting of the second power source 24 into the electric motor system 20 is possible without tools or any modification of the components of the electric motor system. The original cable 16 is removed and replaced by the wire harness 22. Then the second power source 24 is connected to the wire harness 22 and then secured to the personal transportation device. The packaging of the capacitors 40 in the second power device 24 are such that they might even be curved to fit within a curved space.

For example, the capacitors 40 may be heat shrink wrapped using PVC or other equivalent material. The connector 36 is coupled to the capacitors 40 before they are shrink wrapped. The small and shrink-wrapped capacitors 40 are then secured to the personal transportation device such as within the housing of the first power source 12. While it is important to try and add the smaller second power source 24 to the personal transportation device without modification, it may even be possible to dispose the second power source on an outside surface of the personal transportation device without undo inconvenience to the operator of the device or causing any weight imbalance.

In the first embodiment of the present invention, the secondary power source 24 may be waterproof or water resistant, dust-proof, and impact resistant. The secondary power source 24 may also include an internal fuse that provides short-circuit protection for the entire electric motor system 20.

It should be noted that the first embodiment of the invention as shown in FIG. 2 explains that the second power source 24 is coupled in parallel with the first power source 12. Alternatively, the second power source could be used in place of the first power source 12 if the first power source is completely drained of power.

It is also noted that the secondary power source 24 may also include a casing or housing that increases heat resistance. This heat resistance may also protect the first power source 20 and the electric motor 14 from heat.

The issue of safety may also be emphasized for the first embodiment of the invention. When personal transportation devices are operated, they may include components that provide user stability so that the personal transportation device provides a motorized balance to the user. Accordingly, if the motorized balance of the device were compromised such as terminating power in the device, the personal transportation device may no longer provide balance that the user needs to remain in motion and upright. The second power source 24 provides an additional source of power to extend the life of the first power source 12.

Accordingly, the first embodiment of the invention is not only a secondary power source but an added safety device that prevents the personal transportation device from throwing a user from the device when balance is no longer being maintained by the first power source 12 of the personal transportation device.

One of the primary advantages of the present invention is using one or more capacitors to provide electrical power to an electric motor system when capacitors are notoriously problematic when trying to provide a constant voltage. But by using capacitors in combination with a battery, the present invention is able to take advantage of fast charging times, fast discharge rates, rechargeability, modifying without the use of tools to install, a small weight compared to a battery, a small size compared to a battery, and quick and safe replaceability when power is drained. The capacitors ae not only able to extend the capacity of a battery powered system, but also provide more power when peak demands hit an electric load.

In summary, the first embodiment of the present invention is an electric motor system for use in a personal transportation device, said electric motor system comprised of a first power source that includes at least one battery, a second power source that includes at least one capacitor, an electric motor, and a wire harness that is coupled at a motor connector to the electric motor, that is coupled at a first connector to the first power source, and that is coupled at a second connector to the second power source, wherein the wire harness places the first power source and the second power source in a parallel configuration relative to the electric motor.

Furthermore, a method of providing power to an electric motor system for use in a personal transportation device comprises the steps of providing a first power source that includes at least one battery, providing a second power source that includes at least one capacitor, and providing an electric motor, and providing a wire harness that is coupled at a motor connector to the electric motor, that is coupled at a first connector to the first power source, and that is coupled at a second connector to the second power source, wherein the wire harness places the first power source and the second power source in a parallel configuration relative to the electric motor, and operating the electric motor by providing power from the first power source and the second power source.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. It is the express intention of the applicant not to invoke 35 U.S.C. § 112, paragraph 6 for any limitations of any of the claims herein, except for those in which the claim expressly uses the words ‘means for’ together with an associated function.

What is claimed is:

1. An electric motor system for use in a personal transportation device, said electric motor system comprised of:
a first power source that includes at least one battery;
a second power source that includes at least one capacitor;
an electric motor; and
a wire harness that is coupled at a motor connector to the electric motor, that is coupled at a first connector to the first power source, and that is coupled at a second connector to the second power source, wherein the wire harness places the first power source and the second power source in a parallel configuration relative to the electric motor.

2. The electric motor system as defined in claim 1 wherein the motor connector, the first connector and the second connector include an anti-spark feature to thereby prevent damage to the electric motor system whenever the motor connector, the first connector or the second connector are removed or attached.

3. The electric motor system as defined in claim 2 wherein the electric motor is further comprised of at least one motherboard for controlling operation of a stator, a commutator, and a rotor of the electric motor.

4. The electric motor system as defined in claim 3 wherein the at least one capacitor of the second power source is further comprised of two capacitors that are disposed in parallel.

5. The electric motor system as defined in claim 3 wherein the at least one capacitor of the second power source is further comprised of four capacitors that are disposed in parallel.

6. A method of providing power to an electric motor system for use in a personal transportation device, said method comprising:
providing a first power source that includes at least one battery, providing a second power source that includes at least one capacitor, and providing an electric motor; and
providing a wire harness that is coupled at a motor connector to the electric motor, that is coupled at a first connector to the first power source, and that is coupled at a second connector to the second power source, wherein the wire harness places the first power source and the second power source in a parallel configuration relative to the electric motor; and
operating the electric motor by providing power from the first power source and the second power source.
